(19) United States
(12) Patent Application Publication
(10) Pub. No.: US 2012/0007855 A1
(43) Pub. Date: Jan. 12, 2012

(54) CONVERTING METHOD, DEVICE AND SYSTEM FOR 3D STEREOSCOPIC CARTOON, AND RECORDING MEDIUM FOR THE SAME

(76) Inventors: Jun Yong Noh, Daejeon (KR); In Shik Noh, Daejeon (KR); Jung Jin Lee, Daejeon (KR); Sung Woo Choi, Daejeon (KR)

(21) Appl. No.: 13/075,842

(22) Filed: Mar. 30, 2011

(30) Foreign Application Priority Data
Jul. 12, 2010 (KR) 10-2010-0124475

(51) Int. Cl. G06T 15/00

(52) U.S. Cl. 345/419

(57) ABSTRACT

Disclosed herein are a method and a system for stereoscopic three-dimensional (3D) cartoon conversion and a recording medium for the same. In accordance with the method and the system for stereoscopic 3D cartoon conversion and the recording medium for the same, a two-dimensional (2D) digital still image and an alpha map image including depth information are received, and a depth information range, absolute binocular parallax, relative binocular parallax and a screen position are simultaneously controlled based on the depth information included in the alpha map image and a user input, thereby generating a stereoscopic 3D cartoon. Accordingly, it is possible to maximize productivity as compared to a manual operation.

### CROSS-REFERENCE TO RELATED APPLICATION

This application claims priority to Korean Patent Application No. 10-2010-0124475, filed on Dec. 7, 2010, and all the benefits accruing therefrom under 35 U.S.C. §119, the contents of which in its entirety are herein incorporated by reference.

### BACKGROUND OF THE DISCLOSURE

1. Field of the Disclosure

The present disclosure relates to a method and a system for stereoscopic three-dimensional (3D) cartoon conversion and a recording medium for the same, and, more particularly, to a method and a system for converting a two-dimensional (2D) cartoon into a three-dimensional (3D) stereoscopic cartoon and a recording medium for the same.

2. Description of the Related Art

As a display method has been changed from 2 dimensions (2D) to 3 dimensions (3D), a variety of contents are produced in 3D. However, in order to view existing 2D contents in 3D, conversion from 2D into 3D is required.

A 2D moving image can be analyzed and divided into a background object and a foreground object using a method such as an optical flow, such that automatic conversion of the 2D moving image into 3D is possible based on the divided background object and foreground object. However, since it is difficult to acquire the background object and the foreground object from a 2D still image such as a photo, it is difficult to perform conversion of the 2D still image into 3D as compared to the 2D moving image.

### SUMMARY OF THE DISCLOSURE

The present disclosure is directed to providing a stereoscopic three-dimensional (3D) cartoon conversion method for automatically converting a two-dimensional (2D) cartoon and digital comic strip into 3D.

The present disclosure is also directed to providing a stereoscopic 3D cartoon conversion system for automatically converting a 2D cartoon and digital comic strip into 3D.

The present disclosure is also directed to providing a recording medium for the stereoscopic 3D cartoon conversion method.

In one aspect, there is provided a stereoscopic 3-dimensional (3D) cartoon conversion method including receiving a two-dimensional (2D) cartoon type digital still image in which a plurality of objects with a plurality of depths, an alpha map image including first depth information of the 2D digital still image, and second depth information set by a user, generating a stereoscopic 3D image having the plurality of objects of the digital still image with the plurality of depths according to the first depth information included in the alpha map image and the second depth information set by the user, and outputting the stereoscopic 3D image.

The receiving of the 2D digital still image and the alpha map image can further include displaying the received digital 2D digital still image and the alpha map image.

The generating of the stereoscopic 3D image can include determining whether or not the first depth information included in the alpha map information and the second depth information set by the user exceed a predetermined depth information range and controlling at least one of the first and second depth information, controlling absolute parallax of the plurality of objects of the digital still image according to the first depth information included in the alpha map image and the second depth information set by the user, controlling relative parallax of the plurality of objects of the digital still image according to the first depth information included in the alpha map image and the second depth information set by the user, and controlling a screen position where binocular parallax is 0.

In the generating of the stereoscopic 3D image, the determining, the controlling of the absolute parallax, the controlling of the relative parallax, and the controlling of the screen position can be simultaneously performed using a pipeline method.

In another aspect, there is provided a stereoscopic 3D cartoon conversion method including receiving a 2D cartoon type digital still image including a plurality of objects with a plurality of depths and an alpha map image including first depth information of the 2D digital still image, directly receiving second depth information set by a user and generating a stereoscopic 3D image having the plurality of objects of the digital still image with the plurality of depths according to the first depth information included in the alpha map image and the second depth information set by the user, and outputting the stereoscopic 3D image.

The receiving of the 2D digital still image and the alpha map image can further include displaying the received digital still image and alpha map image.

The generating of the stereoscopic 3D image can include determining whether or not the first depth information included in the alpha map information and the second depth information set by the user exceed a predetermined depth information range and controlling at least one of the first and second depth information, controlling absolute parallax of the plurality of objects of the digital still image according to the first depth information included in the alpha map image and the second depth information set by the user, controlling relative parallax of the plurality of objects of the digital still image according to the first depth information included in the alpha map image and the second depth information set by the user, and controlling a screen position where binocular parallax is 0.

In the generating of the stereoscopic 3D image, the determining, the controlling of the absolute parallax, the controlling of the relative parallax, and the controlling of the screen position can be simultaneously performed using a pipeline method.

In another aspect, there is provided a stereoscopic 3D cartoon conversion system including an input unit configured to receive a 2D cartoon type digital still image including a plurality of objects with a plurality of depths, an alpha map image including first depth information of the 2D digital still image, and second depth information set by a user, a conversion unit configured to generate a stereoscopic 3D image having the plurality of objects of the 2D digital still image with the plurality of depths according to the first depth information included in the alpha map image and the second depth information set by the user, and an output unit configured to output the stereoscopic 3D image.

The output unit can display the 2D digital still image and the alpha map image when the 2D digital still image and the alpha map image are input to the input unit.

The conversion unit can include a depth information controlling unit configured to determine whether or not the first depth information included in the alpha map information and the second depth information set by the user exceed a predetermined depth information range and control at least one of the first and second depth information, a depth curve control unit configured to control absolute parallax of the plurality of objects of the 2D digital still image according to the first depth information included in the alpha map image and the second depth information set by the user, a depth weight control unit configured to control relative parallax of the plurality of objects of the 2D digital still image according to the first depth information included in the alpha map image and the second depth information set by the user, and a zero parallax control unit configured to control a screen position where binocular parallax is 0.

The depth information control unit, the depth curve control unit, the depth weight control unit and the zero parallax control unit can simultaneously perform respective operations using a pipeline method.

The input unit can receive the digital still image and the alpha map image from a storage unit.

The output unit can store the stereoscopic 3D image in a storage medium.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a diagram showing an example of a stereoscopic 3D conversion system according to an embodiment of the present disclosure;

FIG. 2 is a diagram showing a principle of displaying a stereoscopic three-dimensional (3D) image;

FIG. 3 is a diagram showing a method of expressing a distance from an object using an image;

FIGS. 4(a) and 4(b) are diagrams showing a method of determining a distance from an object by a person's eyes; and

FIG. 5 is a diagram showing an example of a user interface of a stereoscopic 3D cartoon conversion system according to an embodiment of the present disclosure.

### DETAILED DESCRIPTION

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

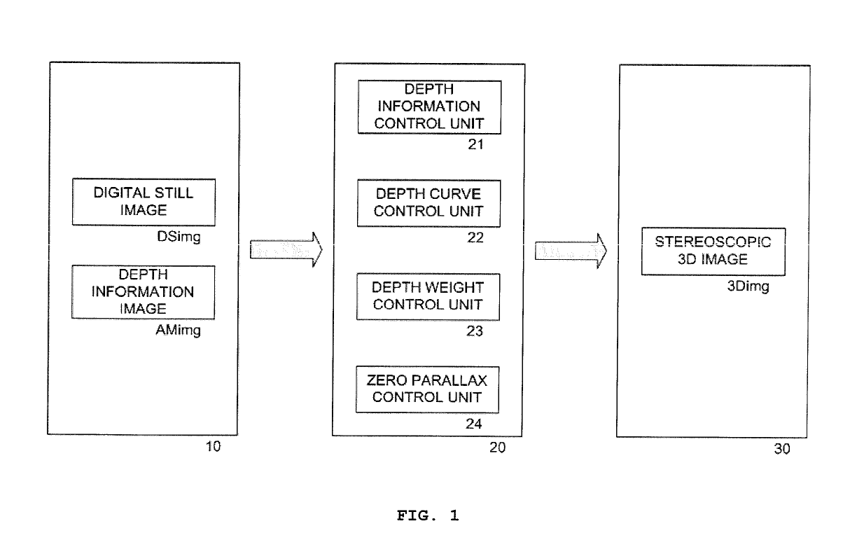

FIG. 1 is a diagram showing an example of a stereoscopic 3D conversion device according to an embodiment of the present disclosure. Referring to FIG. 1, the stereoscopic three-dimensional (3D) cartoon conversion device according to the embodiment includes an input unit 10, a conversion unit 20 and an output unit 30.

The input unit 10 receives and outputs a digital still image (DSimg) and an alpha map image (AMimg) to the conversion unit 20. The digital still image (DSimg) is a two-dimensional (2D) cartoon image.

As described above, since it is difficult to acquire a criterion for dividing the 2D still image into a background object and a foreground object, it is difficult to perform conversion of the 2D still image into 3D as compared to a moving image. However, a 2D still image such as a cartoon or a digital comic strip is produced by artwork of a cartoonist unlike a general photo. In recent years, with development of the digital technology, cartoonists mainly generate digital still images using a variety of graphic software programs such as Photoshop rather than directly drawing a cartoon or a digital comic strip using a pen. In this specification, unless stated otherwise, the digital still image indicates a cartoon or a digital comic strip.

In case the digital still image is generated using the graphic software, most of the graphic software programs provide layers used to display several images to overlap each other. If different images are displayed or printed on a plurality of layers, the different images drawn on the plurality of layers are output to overlap each other. That is, in FIG. 1, the digital still image (DSimg) is an original cartoon or digital comic strip in which the images drawn on the plurality of layers overlap each other. The alpha map image (AMimg) is an individual image drawn on each layer, which includes depth information. A stereoscopic 3D image fundamentally requires a vertical element, a horizontal element and a depth. The depth indicates a sense of distance of an object in a 3D image. When the digital still image is generated using the graphic software, a cartoonist prioritizes the layers in order to generate the digital still image (DSimg). That is, the cartoonist prioritizes the layers such that a layer on which a background image is drawn is placed on a backmost side and an object to be most clearly expressed is placed on a foremost side, and overlaps the images drawn on the plurality of layers according to the set priority so as to generate the digital still image (DSimg). At this time, a part of the image drawn on the layer placed at the back side which overlaps the image drawn on the layer placed at the front side is hidden by the image of the layer of the front side.

Accordingly, the respective images drawn on the layers have different priorities. Since such priorities are used as depth information in the present disclosure, the respective images drawn on the layers are referred to as alpha map images (AMimg). The alpha map is a term which is generally used when a 3D image is generated and is an image map in which the amount of an object included in the image is defined by a value between 0 and 1.

The input unit 10 receives the image of each layer along with the digital still image of a 2D cartoon as the alpha map image (AMimg) and outputs the image to the conversion unit 20.

The input unit 10 can receive the digital still image (DSimg) and the alpha map image (AMimg) from a storage medium or over a communication network such as the Internet. Although not shown, the input unit 10 may separately set depth information of each layer of the alpha map image (AMimg) using an input device such as a mouse or a keyboard.

The conversion unit 20 converts the digital still image (DSimg) and depth information image (DIimg) received from the input unit 10 into a stereoscopic 3D image and outputs the stereoscopic 3D image to the output unit 30. The conversion unit 20 includes a depth information control unit 21, a depth curve control unit 22, a depth weight control unit 23 and a zero parallax control unit 24.

The depth information control unit 21 controls a depth information range. In general, a cartoon or a digital comic strip has a unique way of expression such as frames and speech bubbles. The number of objects and the amount of background expressed in the frame are generally small. The depth information range is controlled such that the user does not set the depth excessively and common expressions such as speech bubbles are expressed with a similar depth. The user can be the cartoonist himself/herself or an operator who converts a 2D digital still image into a stereoscopic 3D image.

The depth curve control unit 22 controls absolute binocular parallax and a depth weight control unit 23 controls relative binocular parallax.

Since a person's eyes are separated from each other by about 6.5 cm, there is a slight difference between an image viewed by a left eye and an image viewed by a right eye. This difference is referred to as binocular parallax. Binocular parallax may be experienced through a simple experiment. If a person has his/her finger at a position close to his/her face and views the finger, the eyes view different images. However, the person recognizes them as one object. This is because the brain automatically synthesizes the two images. In this process, 3D effect is sensed.

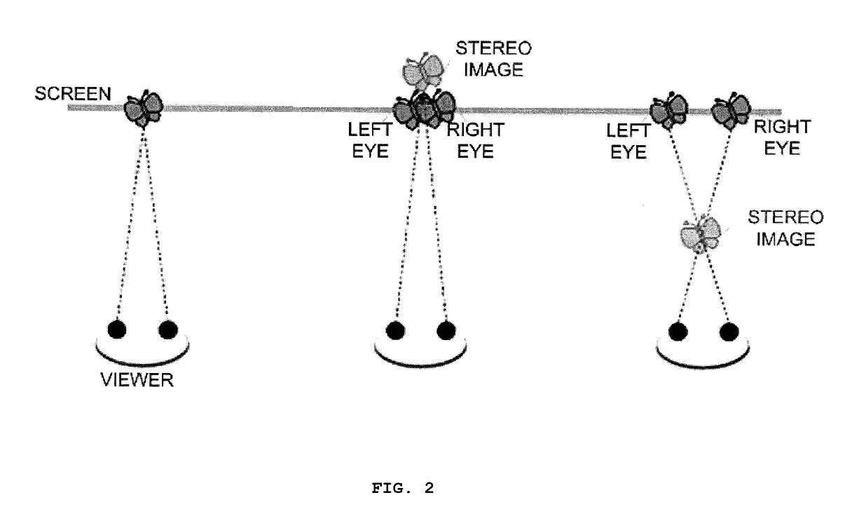

FIG. 2 is a diagram showing a principle of displaying a stereoscopic 3D image.

If a left eye and a right eye view the same image, the person views the image that appears to be displayed on a screen. However, if the left eye and the right eye view images slightly deviated in a horizontal direction, the person feels that the image appears to be located at the back of the screen or appears to protrude from the screen. Thus, he/she senses the 3D effect.

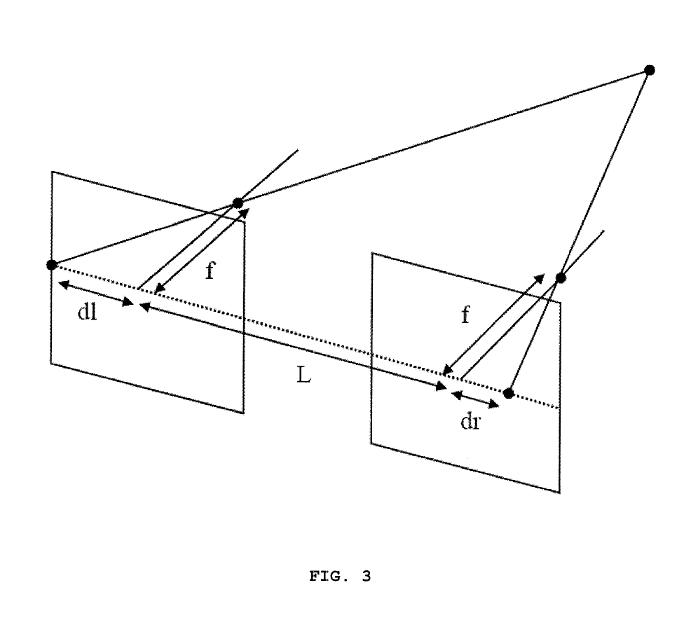

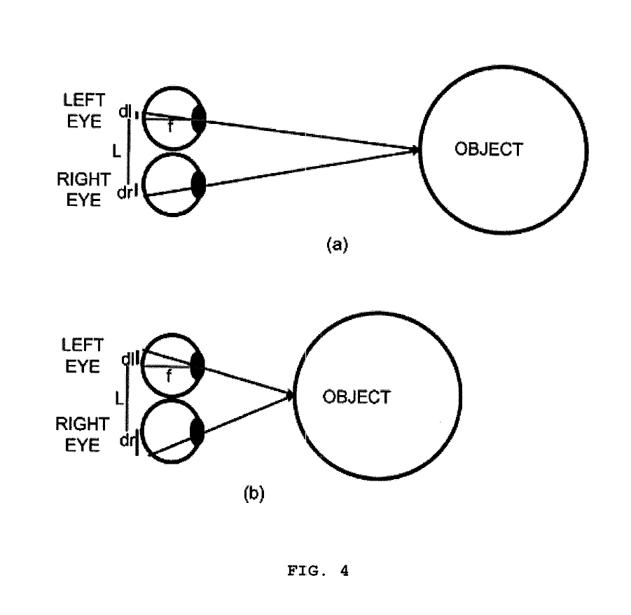

FIG. 3 is a diagram showing a method of expressing a distance from an object using an image, and FIG. 4 is a diagram showing a method of determining a distance from an object by person's eyes. FIG. 4 (a) shows a case where a person views a distant object, and FIG. 4 (b) shows a case where a person views a close object.

Referring to FIGS. 3, 4(a) and 4(b), in FIG. 3, dl is a distance from the center of the retina of the left eye to a place where an image is formed and dr is a distance from the center of the retina of the right eye to a place where an image is formed. In FIGS. 4(a) and 4(b), dl is denoted by the length of a first line, and dr by the length of a second line. In addition, L is a distance between the centers of the eyes (retinas) and is denoted by a third line in FIGS. 4(a) and 4(b). In addition, f is a distance from the retina to a crystalline lens and is denoted by an fourth line in FIGS. 4(a) and 4(b).

If the distance, dl, from the center of the retina of the left eye to the place where the image is formed, and the distance dr from the center of the retina of the right eye to the place where the image is formed, and if the distance L between the centers of the two eyes, and the distance f between the retina and the crystalline lens are set, a distance from the object viewed by the eyes can be calculated the following Equation 1.

$$x = \frac{L \cdot f}{d l + d r} , \qquad Equation 1$$

where x denotes a distance from an object determined by the eyes. In Equation 1, the distance, L, between the centers of the two eyes and the distance, f, from the retina to the crystalline lens are not actually changed. Although they are different from person to person, the distances can be set to constant values since the difference in the distance is not large. Accordingly, the distance from the object is changed according to the distance, dl, from the center of the retina of the left eye to the place where the image is formed and the distance, dr, from the center of the retina of the right eye to the place where the image is formed.

For example, the distance between the eyes and the object shown in FIGS. 4 (a) and (b) can be calculated assuming that the distance L between the centers of the two eyes is 7 cm and the distance f between the retina and the crystalline lens is 3 cm. In FIG. 4 (a), if dl and dr are respectively 0.5 cm and 1 cm, the distance from the object viewed by the eyes is (21/1.5)=14 (cm). In FIG. 4 (b), if dl and dr are respectively 1.5 cm and 3 cm, the distance from the object viewed by the eyes is (21/4.5)=4.666 (cm). That is, it can be seen that the distance between the object and the eyes in FIG. 4 (a) is greater than the distance between the object and the eyes in FIG. 4 (b).

Binocular parallax is divided into absolute binocular parallax and relative binocular parallax. Absolute binocular parallax is the parallax when two eyes view a specific point, and the relative binocular parallax is a secondary difference between objects of the images of the left eye and the right eye irrespective of the point of view. Referring to FIG. 1, the depth curve control unit 22 and the depth weight control unit 23 respectively control the absolute binocular parallax and the relative binocular parallax, thereby increasing a stereoscopic effect with reality.

The zero parallax control unit 24 controls a region, that is, a screen position, where the binocular parallax is 0.

The depth information control unit 21, the depth curve control unit 22, the depth weight control unit 23 and the zero parallax control unit 24 of the conversion unit 20 can simultaneously perform the respective operations using a pipeline method, rather than sequentially performing the respective operations. Accordingly, it is possible to improve productivity.

Although the user separately sets the depth information using the input unit 10 in the above description, the user can directly input the depth information to the depth information control unit 21, the depth curve control unit 22, the depth weight control unit 23 and the zero parallax control unit 24 of the conversion unit 20. And, the user can input the depth information to both the input unit 10 and the conversion unit 20.

The output unit 30 receives the stereoscopic 3D image (3Dimg) generated by the conversion operation of the conversion unit 20, outputs and stores the stereoscopic 3D image using various methods. The output unit 30 can store the stereoscopic 3D image (3Dimg) in a recording medium as data or display or print the stereoscopic 3D image on a monitor.

The stereoscopic 3D cartoon conversion device of the present disclosure can produce a high-quality stereoscopic image based on the depth information. Although the stereoscopic 3D cartoon conversion device uses the conversion method based on layers in the above description, the user can also be allowed to select a pixel shift method or a warping method.

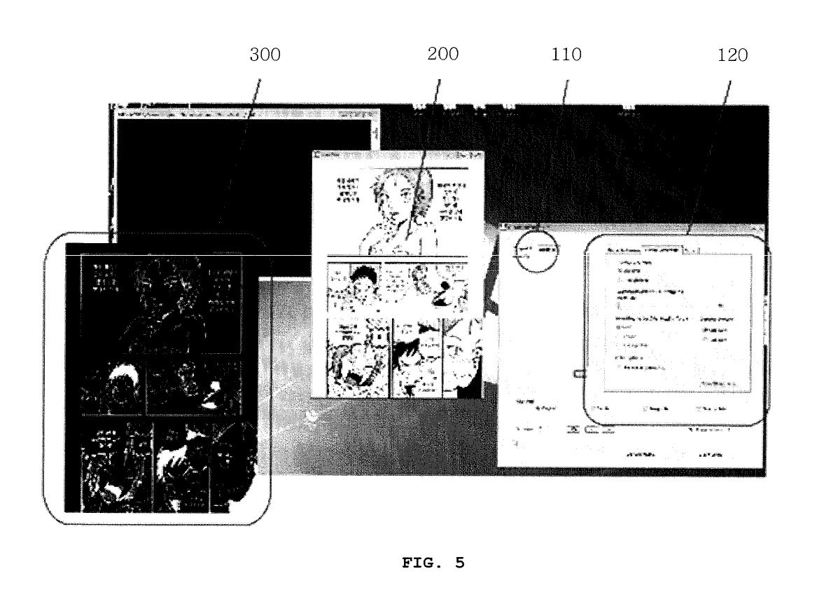

FIG. 5 is a diagram showing an example of a user interface of a stereoscopic 3D cartoon conversion system according to an embodiment of the present disclosure. The stereoscopic 3D cartoon conversion system according to the embodiment can further include an input unit for inputting a user input to the stereoscopic 3D cartoon conversion device of FIG. 1, such as a keyboard or a mouse, and a display unit for outputting a digital still image, an alpha map image and a stereoscopic 3D image, such as a monitor.

Referring to FIG. 5, the user interface of the stereoscopic 3D cartoon conversion system according to the embodiment includes an image load window 110 and a depth information control window 120. The image load window 110 includes a digital still image load tab and an alpha map image load tab. The user can load a digital still image stored in a storage medium or received through communication. If the user loads the digital still image, the stereoscopic 3D cartoon conversion system displays the digital still image on a new window 200. Similarly, if the user loads an alpha map image from the alpha map image load tab, the stereoscopic 3D cartoon conversion system displays the alpha map image on a new window 300.

The depth information control window 120 enables the user to input the depth information to the depth information control unit 21, the depth curve control unit 22, the depth weight control unit 23 and the zero parallax control unit 24 of FIG. 1.

Since the stereoscopic 3D cartoon conversion system of the embodiment rapidly performs conversion using the pipeline method, the user can control the depth curve and the depth weight, and confirm the converted stereoscopic 3D image in real time.

Although the cartoon and the digital comic strip are described in the above description, the embodiment is also applicable to movie continuity that is produced in the form of a cartoon.

According to the stereoscopic 3D cartoon conversion method and system and the recording medium of the present disclosure, since a digital still image of a 2D cartoon and digital comic strip are converted into a high-quality stereoscopic 3D cartoon image, the existing webtoon or cartoon market can evolve into a new cartoon market. Also a frame of a cartoon, a speech bubble and a graphic scene can be converted using an automatic conversion technology so as to maximize a sense of depth and frame display effect, and a stereoscopic 3D mobile device with satisfactory visual effect and display effect can be mounted so as to provide graphic contents with reality.

While the exemplary embodiments have been shown and described, it will be understood by those skilled in the art that various changes in form and details may be made thereto without departing from the spirit and scope of the present disclosure as defined by the appended claims.

In addition, many modifications can be made to adapt a particular situation or material to the teachings of the present disclosure without departing from the essential scope thereof. Therefore, it is intended that the present disclosure not be limited to the particular exemplary embodiments disclosed as the best mode contemplated for carrying out the present disclosure, but that the present disclosure will include all embodiments falling within the scope of the appended claims.

1. A stereoscopic 3-dimensional (3D) cartoon conversion method comprising:
receiving a 2-dimensional (2D) cartoon type digital still image including a plurality of objects with a plurality of depths, an alpha map image including first depth information of the 2D digital still image, and second depth information set by a user;
generating a stereoscopic 3D image having the plurality of objects of the digital still image with the plurality of depths according to the first depth information included in the alpha map image and the second depth information set by the user; and
outputting the stereoscopic 3D image.

2. The stereoscopic 3D cartoon conversion method according to claim 1, wherein the receiving of the 2D digital still image and the alpha map image further includes displaying the received digital 2D digital still image and the alpha map image.

3. The stereoscopic 3D cartoon conversion method according to claim 1, wherein the generating of the stereoscopic 3D image includes:
determining whether or not the first depth information included in the alpha map information and the second depth information set by the user exceed a predetermined depth information range and controlling at least one of the first and second depth information;
controlling absolute parallax of the plurality of objects of the 2D digital still image according to the first depth information included in the alpha map image and the second depth information set by the user;
controlling relative parallax of the plurality of objects of the 2D digital still image according to the first depth information included in the alpha map image and the second depth information set by the user; and
controlling a screen position where binocular parallax is 0.

4. The stereoscopic 3D cartoon conversion method according to claim 3, wherein the determining, the controlling of the absolute parallax, the controlling of the relative parallax, and the controlling of the screen position are simultaneously performed using a pipeline method.

5. A stereoscopic 3-dimensional (3D) cartoon conversion method comprising:
receiving a 2-dimensional (2D) cartoon type digital still image including a plurality of objects with a plurality of depths and an alpha map image including first depth information of the 2D digital still image;
directly receiving second depth information set by a user and generating a stereoscopic 3D image having the plurality of objects of the digital still image with the plurality of depths according to the first depth information included in the alpha map image and the second depth information set by the user; and
outputting the stereoscopic 3D image.

6. The stereoscopic 3D cartoon conversion method according to claim 5, wherein the receiving of the 2D digital still image and the alpha map image further includes displaying the received 2D digital still image and alpha map image.

7. The stereoscopic 3D cartoon conversion method according to claim 5, wherein the generating of the stereoscopic 3D image includes:
determining whether or not the first depth information included in the alpha map information and the second depth information set by the user exceed a predetermined depth information range and controlling at least one of the first and second depth information;
controlling absolute parallax of the plurality of objects of the 2D digital still image according to the first depth information included in the alpha map image and the second depth information set by the user;
controlling relative parallax of the plurality of objects of the 2D digital still image according to the first depth information included in the alpha map image and the second depth information set by the user; and
controlling a screen position where binocular parallax is 0.

8. The stereoscopic 3D cartoon conversion method according to claim 7, wherein the determining, the controlling of the absolute parallax, the controlling of the relative parallax, and the controlling of the screen position are simultaneously performed using a pipeline method.

9. A stereoscopic 3-dimensional (3D) cartoon conversion system comprising:
an input unit configured to receive a 2-dimensional (2D) cartoon type digital still image including a plurality of objects with a plurality depths, an alpha map image including first depth information of the 2D digital still image, and second depth information set by a user;
a conversion unit configured to generate a stereoscopic 3D image having the plurality of objects of the 2D digital still image with the the plurality of depths according to the first depth information included in the alpha map image and the second depth information set by the user; and
an output unit configured to output the stereoscopic 3D image.

10. The stereoscopic 3D cartoon conversion system according to claim 9, wherein the output unit displays the 2D digital still image and the alpha map image when the 2D digital still image and the alpha map image are input to the input unit.

11. The stereoscopic 3D cartoon conversion system according to claim 9, wherein the conversion unit includes:
a depth information control unit configured to determine whether or not the first depth information included in the alpha map information and the second depth information set by the user exceed a predetermined depth information range and control at least one of the first and second depth information;
a depth curve control unit configured to control absolute parallax of the plurality of objects of the 2D digital still image according to the first depth information included in the alpha map image and the second depth information set by the user;
a depth weight control unit configured to control relative parallax of the plurality of objects of the 2D digital still image according to the first depth information included in the alpha map image and the second depth information set by the user; and
a zero parallax control unit configured to control a screen position where binocular parallax is 0.

12. The stereoscopic 3D cartoon conversion system according to claim 11, wherein the depth information control unit, the depth curve control unit, the depth weight control unit and the zero parallax control unit simultaneously perform respective operations using a pipeline method.

13. The stereoscopic 3D cartoon conversion system according to claim 9, wherein the input unit receives the 2D digital still image and the alpha map image from a storage unit.

14. The stereoscopic 3D cartoon conversion system according to claim 9, wherein the output unit stores the stereoscopic 3D image in a storage medium.
